(19) United States
(12) Patent Application Publication
(10) Pub. No.: US 2026/0183792 A1
(43) Pub. Date: Jul. 2, 2026

(54) Producing a Saddle Coil for a Gradient Coil Unit

(71) Applicant: Siemens Healthineers AG, Forchheim (DE)

(72) Inventors: René Maier, Leinburg (DE); Steffen Lang, Hallerndorf (DE); Andreas Johannes Fischer, Erlangen (DE)

(73) Assignee: Siemens Healthineers AG, Forchheim (DE)

(21) Appl. No.: 19/429,405

(22) Filed: Dec. 22, 2025

(30) Foreign Application Priority Data
Dec. 27, 2024 (DE) 10 2024 212 310.2

(51) Int. Cl. B05D 7/16; B05D 1/00; B05D 1/12

(52) U.S. Cl. CPC B05D 7/16; B05D 1/007; B05D 1/12

(57) ABSTRACT

The disclosure relates to a method for producing a saddle coil for a gradient coil unit, comprising providing a stabilizing support, a planar and at least partially spiral-shaped conductor structure unit, and a powder designed to form a powder coating when heated; applying the powder as a surface layer to a first surface of the stabilizing support and/or as a surface layer to a first side of the conductor structure unit, the powder being exposed to a temperature of between 140° C. and 220° C. and forming a lacquer film that at least partially wets the first surface and/or the first side; and fixing the conductor structure unit to the stabilizing support by pressing the stabilizing support together with the conductor structure unit and by curing the lacquer film to form a powder coating, the first side of the conductor structure unit facing the first surface of the stabilizing support.

### CROSS-REFERENCE TO RELATED APPLICATIONS

The present application claims priority to and the benefit of Germany patent application no. DE 10 2024 212 310.2, filed on Dec. 27, 2024, the contents of which are incorporated herein by reference in their entirety.

### TECHNICAL FIELD

The disclosure relates to a method for producing a saddle coil for a gradient coil unit and to a corresponding saddle coil.

### BACKGROUND

In a magnetic resonance device, a body to be examined of an object under examination, in particular a patient, is typically exposed to a relatively strong main magnetic field, for example of 1.5 or 3 tesla, produced by a main magnet. During magnetic resonance imaging (MRI), gradient pulses are played out (i.e. transmitted) using a gradient coil unit. In addition, radiofrequency (RF) pulses, in particular excitation pulses, are then transmitted via a radiofrequency antenna unit by means of suitable antenna arrangements, causing the nuclear spins of particular atoms resonantly excited by these RF pulses to be tilted by a defined flip angle relative to the lines of force of the main magnetic field. As the nuclear spins relax, radiofrequency signals, so-called magnetic resonance signals, are emitted, which are received by suitable radiofrequency antennas before undergoing further processing. Finally, the desired image data can be reconstructed from the raw data acquired in this way.

For a given measurement, a specific magnetic resonance control sequence (MR control sequence), also referred to as a pulse sequence, must therefore be transmitted, consisting of a sequence of radiofrequency pulses, for example excitation and refocusing pulses, and of gradient pulses to be emitted in a coordinated manner along various gradient axes in different spatial directions. With appropriate timing, readout windows are set that define the time periods in which the induced magnetic resonance signals are detected.

A gradient coil unit conventionally comprises three primary coils and three corresponding secondary coils. A primary coil is typically designed to generate a magnetic field gradient in one spatial direction, in particular inside a patient tunnel. A magnetic field gradient is typically a first-order and/or a linear-order magnetic field, in particular a magnetic field with an amplitude that increases linearly along one spatial direction. A primary coil is typically arranged on a cylindrical surface. A primary coil for generating a magnetic field gradient in the x-direction and/or y-direction typically comprises four conductor structures. The four conductor structures are typically arranged symmetrically with respect to one another and/or in respective quadrants of the cylindrical surface. Each of the four conductor structures is typically saddle-shaped. A conductor structure typically defines a geometrical arrangement of an electrical conductor, in particular of an electrical conductor disposed on the lateral surface of a cylinder, which conductor is preferably at least partially of spiral shape. A conductor structure therefore typically has windings and is arranged in a plane (i.e. a two-dimensional surface). In the final form of the gradient coil unit, the plane comprises a surface of a cylinder having half the circumference and half the length of the gradient coil unit, in particular the surface of a quadrant of a cylinder.

In the course of producing gradient coil units, saddle coils are typically fabricated first, wherein a saddle coil comprises two saddle-shaped conductor structures and a corresponding stabilizing support. A glass-fiber-reinforced plastic plate is typically used as the stabilizing support, which initially forms a flat surface. An initially still planar conductor structure unit is typically fixed thereon, typically by spraying or laminating the entire surface of the stabilizing support with adhesive. Such a planar conductor structure unit comprises two conductor structures before their deformation into a saddle shape, wherein these two conductor structures are assigned to adjacent quadrants in the longitudinal direction of the gradient coil unit to be formed.

The two conductor structures of a conductor structure unit are typically electrically interconnected. Conventionally, the stabilizing support and the conductor structure unit are then jointly deformed into a saddle shape, thereby forming a saddle coil, in particular by convex or concave deformation. The resulting saddle coil typically has a spatial extent in the circumferential direction of half the circumference of a cylindrical surface and/or a spatial extent in the longitudinal direction corresponding to at least 90% of the longitudinal direction of the primary coil and/or 80% of the longitudinal direction of the gradient coil unit.

### SUMMARY

The convex or concave deformation of the conductor structure unit along with the stabilizing support to achieve the saddle shape of the saddle coil must be carried out with particular precision and dimensional stability, so that storage of the saddle coils prior to encapsulation with further saddle coils and/or assembly thereof can be performed in a robust manner.

The object of the disclosure is to provide a method for producing particularly stable saddle coils for gradient coil units. This object is achieved by the features of the independent claims. Advantageous embodiments are described in the dependent claims.

The method according to the disclosure for producing a saddle coil for a gradient coil unit comprises the following steps:
providing a stabilizing support,
providing a planar and at least partially spiral-shaped conductor structure unit,
providing a powder designed to form a lacquer film when heated,
applying the powder as a surface layer to a first surface of the stabilizing support and/or applying the powder as a surface layer to a first side of the conductor structure unit,
   wherein the powder is exposed to a temperature between 140° C. and 220° C. and forms a lacquer film which at least partially wets the first surface and/or the first side,
fixing the conductor structure unit to the stabilizing support by pressing the stabilizing support together with the conductor structure unit and by curing the lacquer film to form a powder coating, wherein the first side of the conductor structure unit faces the first surface of the stabilizing support.

The stabilizing support is typically in the form of a plate and/or a flat surface. The stabilizing support may e.g. comprise a material that is stable yet slightly flexible, such as being bendable under pressure and/or heat. The stabilizing support may e.g. comprise a glass-fiber-reinforced plastic plate. The stabilizing support, e.g. the glass-fiber-reinforced plastic plate, may be provided with perforations and/or mechanical reinforcement.

The spiral-shaped conductor structure unit (also referred to herein as a spiral-shaped conductor structure of simply as a conductor structure) may for instance comprise two conductor structures arranged adjacent to one another and/or electrically interconnected, the two conductor structures e.g. being disposed in the same plane. A conductor structure typically comprises an electrical conductor that is arranged within a plane and is at least partially spiral in shape and/or has a fingerprint-like structure. The conductor structure unit may be planar, for instance having a flat design. The conductor structure unit and the stabilizing support may each be typically planar, so that each has two sides with a large surface area and/or can each be referred to as a surface.

The powder typically has a melting temperature above which it becomes viscous at sufficient spatial density and, when applied to a surface, forms a film, e.g. a lacquer film, which wets the corresponding surface. The lacquer film is typically liquid and/or viscous.

According to the disclosure, the powder may be e.g. applied as a surface layer and may be e.g. applied uniformly to a first side of the conductor structure unit and/or to a first surface of the stabilizing support. The powder may be e.g. applied to the conductor structure unit at room temperature, such as electrostatically for instance. Alternatively, the powder can may be e.g. sprayed onto the stabilizing support. During and/or after application of the powder, heat may be applied to the powder so that the powder is typically exposed temporarily to a temperature of between any suitable range, such as between 140° C. and 220° C., between 155° C. and 205° C., between 170° C. and 190° C., etc., and/or reaches such temperatures. This typically causes the powder to melt, thereby forming a lacquer film which, in its liquid (typically viscous) state at higher temperatures, wets the first side of the conductor structure unit and/or the first surface of the stabilizing support. After curing to form a powder coating, such a lacquer film typically has fixing (e.g. bonding) properties.

To produce the saddle coil, the first side of the conductor structure unit is placed onto the first surface of the stabilizing support, wherein the lacquer film forming the powder coating and connecting the two surfaces is present on the conductor structure unit and/or the stabilizing support before the two surfaces are brought together.

Pressing the stabilizing support together with the conductor structure unit typically involves bringing the stabilizing support together with the conductor structure unit and applying surface pressure to the stabilizing support and the conductor structure unit. Pressing the stabilizing support together with the conductor structure unit may consist for instance of placing the conductor structure unit down onto the stabilizing support, e.g. without active application of pressure, the conductor structure unit and stabilizing support being aligned horizontally. The pressing together of the stabilizing support and the conductor structure unit can be carried out with application of pressure and heat, typically e.g. at 200° C. While the conductor structure unit is being pressed together with the stabilizing support, the lacquer film is typically viscous and/or exhibits wetting properties. Fixation additionally requires curing of the lacquer film, the latter forming a powder coating that acts as a bonding agent between the conductor structure unit and the stabilizing support. The lacquer film is typically cured at a temperature between 140° C. and 220° C., causing the lacquer film to form a powder coating. This powder coating is typically stable and acts as a bonding agent between the conductor structure unit and the stabilizing support. An embodiment of the method may provide for active cooling of the powder coating.

The method according to the disclosure provides that the melting process produces, from the powder, a lacquer film that wets the conductor structure unit and/or stabilizing support over their respective surface areas. Such a lacquer film is typically viscous and wets the stabilizing support and/or conductor structure unit e.g. uniformly, enabling the conductor structure unit to be adhesively fixed to the stabilizing support in a particularly robust manner and preventing delamination. A powder coating serving as the bonding element is also particularly stable. As a result, the mechanical stability and dielectric strength of the saddle coil are improved, thereby preventing partial discharges and spikes during operation of the corresponding gradient coil unit.

One embodiment of the method provides that the powder and/or the powder coating comprises an epoxy. The epoxy may e.g. be based on a resin and a hardener which form the epoxy via a chemical reaction. The epoxy may also comprise a filler, e.g. fused silica and/or crystalline quartz powder. The resin may comprise a chain-extended diglycidyl ether, in particular a bisphenol-A-based diglycidyl ether, and/or epoxidized novolac. The hardener may comprise dicyandiamide. The powder may also comprise a degassing agent, which may be in any suitable proportion by weight such as for instance between 1 and 3 percent by weight, 2 percent by weight, etc.

Such materials are readily available and allow the toughness to be selected with regard to the required robustness of the saddle coil both during pressing of the stabilizing support together with the conductor structure unit and in the course of convex or concave deformation, as well as during epoxy resin encapsulation with other saddle coils to form the final gradient coil unit. Moreover, by selecting an appropriate mixing ratio of resin, hardener, and filler, the glass transition temperature and the viscosity of the powder coating can be varied. This makes it possible to improve the processability and stability of the saddle coil and/or to optimize stress build-up during convex or concave deformation of the stabilizing support together with the conductor structure unit.

One embodiment of the method provides that the powder comprises isocyanate and polyols and/or that the powder coating comprises polyurethane. Such a powder is inexpensive and commercially available. In addition, the glass transition temperature can be individually adjusted by suitable composition of the raw components.

One embodiment of the method provides that the powder and/or the powder coating is solvent-free and/or free from per- and polyfluorinated alkyl compounds. A resulting powder coating can be processed in a particularly safe and sustainable manner.

One embodiment of the method provides that the resulting powder coating has a layer thickness between any suitable range of values, such as for instance between 10 μm and 200 μm, between 30 μm and 150 μm, between 60 μm and 100 μm, etc. The thickness of the layer may be adjusted by the amount and/or spatial density of the powder applied. A powder coating layer of this thickness covers the stabilizing support and/or the conductor structure unit in a particularly uniform manner. As an example, such a layer thickness allows good degassing of the powder during melting, allowing the powder to fuse uniformly and without pores. This improves the adhesive and/or fixing properties of the powder coating and the formation of particularly stable bonds, for example between the stabilizing support and the conductor structure unit.

One embodiment of the method provides for pore-free formation of the powder coating. A precisely selected quantity and/or spatial density, together with uniform application of the powder to the first side and/or the first surface, allow gases to escape during melting, so that pore formation during melting of the powder can be avoided. The resulting lacquer film is typically pore-free, thereby enabling a pore-free powder coating to be formed. This improves the adhesive and/or fixing properties of the powder coating and the formation of particularly stable bonds in the solidified state, e.g. between the stabilizing support and the conductor structure unit.

One embodiment of the method provides that the curing of the lacquer film and formation of the powder coating involves chemical curing. The powder may e.g. comprise monomers that are cross-linked during chemical curing to form a solid, e.g. a thermoset, which can be referred to as a powder coating. Chemical curing typically takes place at temperatures of e.g. between 140° C. and 220° C., between 160° C. and 210° C., between 180° C. and 205° C., etc., for a defined duration, typically e.g. at least one minute, at least three minutes, at least five minutes, etc. Chemical curing ensures that the powder coating retains its stability and fixing properties even when reheated.

The lacquer film can be cured to form a powder coating during the pressing-together of the stabilizing support and the conductor structure unit. Curing of the lacquer film to form the powder coating may take place e.g. during the convex or concave deformation of the pressed-together stabilizing support and conductor structure unit to form the saddle coil. The curing of the lacquer film and the formation of the powder coating typically take place e.g. under application of heat and/or at temperatures of e.g. between 140° C. and 220° C., between 160° C. and 210° C., between 180° C. and 205° C., etc., and for a defined period of time.

One embodiment of the method additionally involves heating of the stabilizing support during surface-wide application of the powder. The stabilizing support can be heated, for example, by placing the stabilizing support on a hot metal block that transfers heat to the stabilizing support, thereby increasing the temperature of the stabilizing support. The target temperature for the stabilizing support through active heating according to this embodiment may be e.g. between 140° C. and 250° C., between 150° C. and 240° C., between 170° C. and 230° C., etc. Heating of the stabilizing support allows the powder, during and/or after its application to the stabilizing support, to be exposed to a temperature of e.g. between 140° C. and 220° C., thus forming a lacquer film.

This embodiment can be particularly advantageously combined with the surface-wide application of the powder to the first surface of the stabilizing support: the stabilizing support heated according to this embodiment typically initiates melting of the powder disposed on the first surface, causing the powder to melt and form a lacquer film. In an embodiment, the powder is applied as a surface layer covering the first surface of the stabilizing support heated according to this embodiment. In the process, the powder melts and is degassed, e.g. aided by a degassing agent contained in the powder. If the stabilizing support is heated by placing it on a hot metal block, the stabilizing support can be rapidly cooled by removing it from the hot metal block, causing the lacquer film to transition from a liquid to a solid state. If cooling is sufficiently rapid, chemical curing is advantageously avoided, leaving the lacquer film chemically reactive. This embodiment enables rapid and robust application of the lacquer film and/or powder coating to the first surface. In addition, the lacquer film can be reheated at a later time, typically during fixing of the conductor structure unit to the stabilizing support, and cured with appropriate application of heat. This simplifies processing of the powder.

One embodiment of the method additionally involves heating the stabilizing support and/or the powder and/or the lacquer film to a temperature of e.g. between 140° C. and 220° C. during fixing of the conductor structure unit to the stabilizing support. Curing of the lacquer film to form the powder coating typically takes place in the temperature range e.g. between 140° C. and 220° C., between 155° C. and 205° C., between 170° C. and 190° C., etc., whereby the lacquer film develops fixing properties that are required, at least to some extent, for fixing the conductor structure unit to the stabilizing support. This embodiment provides reliable fixing.

Any of the aforementioned embodiments may for instance be combined such that the stabilizing support is heated, for example by placing the stabilizing support on a hot metal block. The powder can be applied as a surface layer to this stabilizing support heated to approximately 190° C., where it melts to form a lacquer film that wets the stabilizing support. The conductor structure unit may e.g. be placed onto the lacquer film, thereby causing it to be bonded to the stabilizing support by the lacquer film. During this process, the stabilizing support can continue to be actively heated, for example by remaining positioned on the hot metal block. Pressing of the stabilizing support together with the conductor structure unit can be performed with or without the application of heat, for example using a laminating press. If heat is supplied for more than a defined period of time, the lacquer film typically cures to form a powder coating.

One embodiment of the method provides that the conductor structure unit comprises a copper wire having a coated surface. Copper has high electrical conductivity and is readily formable, which allows precise arrangement of the electrical conductor in loops and/or spirals for the conductor structure unit. The copper wire typically has a surface coating of wire enamel, polyester, polyesterimide, polyimide, and/or polyamideimide. The coating can be two-layered. For example, the coating can comprise layers of polyester and polyamideimide or layers of polyesterimide and polyamideimide. Such a coating typically provides electrical insulation and is easy to process. In addition, the powder coating adheres well to such a wire coating, allowing the conductor structure unit to be fixed stably on the stabilizing support while retaining its electrically insulating property. The conductor structure unit may also comprise a hollow conductor.

One embodiment of the method provides that the powder and/or powder coating has a glass transition temperature of no more than any suitable temperature, such as for instance no more than 90° C., no more than 80° C., no more than 70° C., etc. Such a powder coating can be deformed at room temperature, allowing convex or concave deformation into a saddle coil at room temperature. The relatively low glass transition temperature of the powder coating according to this embodiment reduces its brittleness, particularly at room temperature and especially compared to conventionally used adhesive sheet films, which typically have a glass transition temperature of 120° C. This reduces mechanical stresses during deformation.

One embodiment of the method additionally involves forming a saddle coil by convex or concave deformation of the stabilizing support pressed together with the conductor structure unit to produce a saddle-like shape. Convex or concave deformation of a surface into a saddle shape can be understood as meaning that the surface is rolled onto the lateral surface of a cylinder, wherein the radius of the cylinder is selected such that the surface covers approximately half the circumferential direction of the cylinder, e.g. approximately 180°. The convex or concave deformation is preferably plastic. The convex or concave deformation can be e.g. achieved by means of a rolling process. This is particularly advantageous in combination with a powder coating having a glass transition temperature of no more than any suitable temperature such as for instance no more than 90° C., no more than 80° C., no more than 70° C., etc., since such a powder coating is less brittle than conventional adhesive films and consequently mechanical stresses during deformation are lower. This can also reduce delamination and downtimes. The desired glass transition temperature can typically be achieved by selecting the powder mixing ratio appropriately. Convex or concave deformation can be achieved by bending. Convex or concave deformation can also be achieved by applying heat, causing the powder coating to temporarily lose its rigidity.

One embodiment of the method additionally involves providing further saddle coils and encapsulating the saddle coil and the further saddle coils with potting compound, in particular epoxy resin, to form a hollow cylinder.

In an embodiment, each primary coil for generating a magnetic field gradient in the x-direction and in the y-direction comprises at least two saddle coils arranged opposite each other in the circumferential direction. The saddle coils for generating a magnetic field gradient in the x-direction are typically arranged in the circumferential direction rotated by 90° with respect to the saddle coils for generating a magnetic field gradient in the y-direction. The primary coil for generating a magnetic field gradient in the z-direction is generally of different design and typically does not require a saddle coil. According to this embodiment, at least three further saddle coils may be provided, each produced according to any of the methods discussed throughout the present disclosure. After appropriate geometric arrangement relative to one another, these are typically encapsulated together, for example with epoxy resin. Due to the particular stability of the saddle coil and/or the further saddle coils produced according to the disclosure, uncontrolled displacement of the saddle coils during encapsulation with potting compound can be avoided. This embodiment of the method may e.g. be used to produce a gradient coil unit.

One embodiment of the method provides that the powder is spray-applied to the surface of the stabilizing support, the stabilizing support having a temperature of 200° C. The powder typically melts on contact with the stabilizing support and forms a liquid lacquer film that wets the stabilizing support. In the process, a degassing agent contained in the powder typically sublimates and degasses the lacquer film, allowing bubbles to escape and/or rendering the lacquer film bubble-free. Rapid cooling typically causes the lacquer film to solidify while maintaining chemical reactivity. If the lacquer film is exposed to a temperature of more than 160° C., such as e.g. 200° C., during curing, the lacquer film becomes liquid again and chemically reactive. In this state of the lacquer film, the stabilizing support may be pressed together with the conductor structure unit in accordance with this embodiment. Maintaining the temperature of more than 160° C., e.g. 200° C., for example for 5 minutes, results in chemical curing of the lacquer film to form a powder coating in accordance with this embodiment.

The disclosure further relates to a saddle coil for a gradient coil unit comprising a stabilizing support, a conductor structure unit extending over a surface area and at least partially spiral-shaped, and a powder coating, wherein the powder coating bonds and/or fixes the conductor structure unit to the stabilizing support over a surface area, e.g. permanently. The stabilizing support and the conductor structure unit are saddle-shaped, and the saddle coil has a convex or concave shape.

One embodiment of the saddle coil provides that it has been produced by a method according to the disclosure for producing a saddle coil for a gradient coil unit.

One embodiment of the saddle coil provides that the powder coating comprises epoxy and/or polyurethane and/or is free from solvents and/or free from per- and polyfluorinated alkyl compounds. One embodiment of the saddle coil provides that the powder coating is pore-free. One embodiment of the saddle coil provides that the conductor structure unit comprises a copper wire. One embodiment of the saddle coil provides that the powder coating has a layer thickness of between 30 μm and 150 μm.

The disclosure further relates to a gradient coil unit comprising at least four saddle coils according to the disclosure, which are encapsulated together with potting compound in the form of a hollow cylinder.

Further embodiments of the saddle coil and the gradient coil unit according to the disclosure are of analogous form to the embodiments of the method according to the disclosure.

The advantages of the saddle coil according to the disclosure and the gradient coil unit according to the disclosure correspond essentially to the advantages of the method according to the disclosure for producing a saddle coil for a gradient coil unit, as described in detail above. The features, advantages, or alternative embodiments mentioned therein are likewise applicable to the other claimed subject matters and vice versa.

### BRIEF DESCRIPTION OF THE DRAWINGS

Further advantages, features, and details of the disclosure will emerge from the exemplary embodiments described below and from the associated drawings, in which:

FIG. 1 illustrates an example saddle coil in a first view, in accordance with an embodiment of the present disclosure;

FIG. 2 illustrates an example saddle coil in a second view, in accordance with an embodiment of the present disclosure;

FIG. 3 illustrates an example conductor structure unit pressed together with a stabilizing support in a third view, in accordance with an embodiment of the present disclosure;

FIG. 4 illustrates a first example flow diagram, in accordance with an embodiment of the present disclosure; and

FIG. 5 illustrates a second flow diagram, in accordance with an embodiment of the present disclosure.

### DETAILED DESCRIPTION OF THE DISCLOSURE

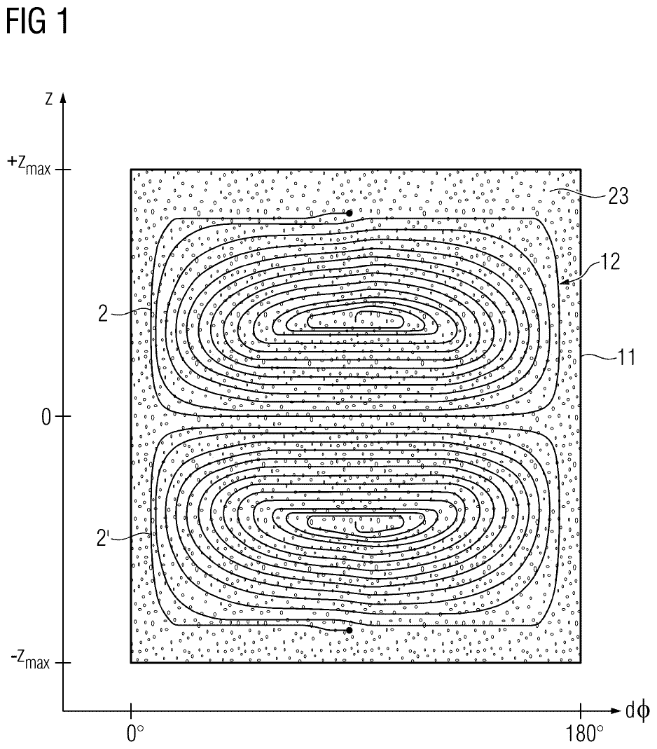

FIG. 1 illustrates an example saddle coil in a first view, in accordance with an embodiment of the present disclosure. FIG. 1 shows, in a first view, a first embodiment of a conductor structure unit 12 according to the disclosure pressed together with the stabilizing support 11, wherein the conductor structure unit 12 is fixed to the stabilizing support 11 by the powder coating 23.

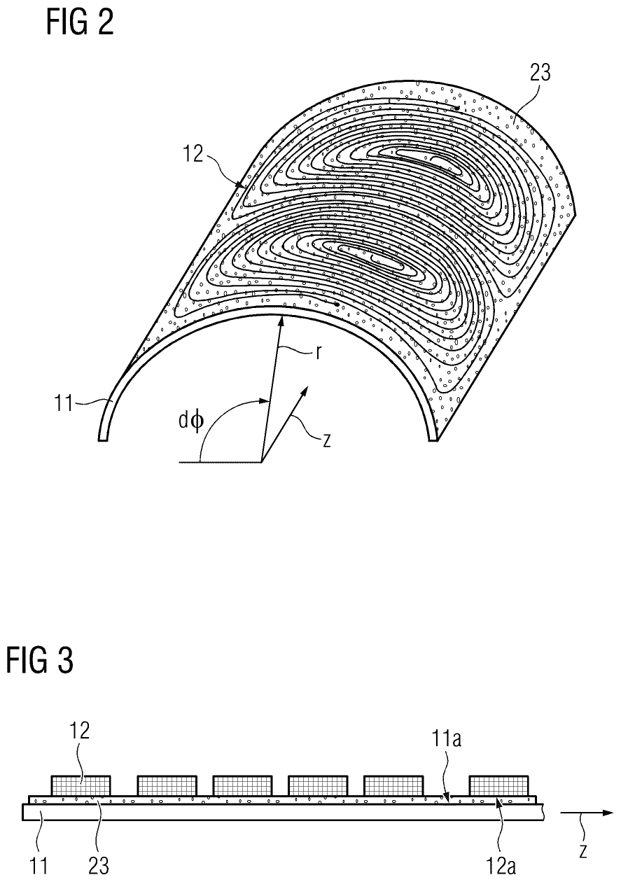

The conductor structure unit 12 comprises two conductor structures 2, 2′, each of the two conductor structures 2, 2′being at least partially spiral-shaped and comprising e.g. copper wire. The view in FIG. 1, disregarding the coordinate system indicated, corresponds to the planar view after pressing. Taking the coordinate system into account, the view in FIG. 1 corresponds to the convexly or concavely deformed saddle coil according to process step 160 and covering the entire length [zmin; zmax] in the longitudinal direction and half the circumferential direction dφ [0°, 180°] of a gradient coil. This convexly or concavely deformed saddle coil according to the first embodiment is shown in FIG. 2 in a second view. In this case, the radial direction r is perpendicular to the circumferential direction dφ and to the longitudinal direction z.

FIG. 3 illustrates an example conductor structure unit pressed together with a stabilizing support in a third view, in accordance with an embodiment of the present disclosure. FIG. 3 shows an embodiment of a conductor structure unit 12 pressed together with the stabilizing support 11 in a third view. The powder coating 23 bonds the first side 12a of the conductor structure unit 12 to the first surface 11a of the stabilizing support 11 so that the powder coating 23 acts as a fixing agent between the conductor structure unit 12 and the stabilizing support 11. The spatial extent of the powder coating 23 perpendicular to the longitudinal direction z may be e.g. approximately 60μm to 100 μm.

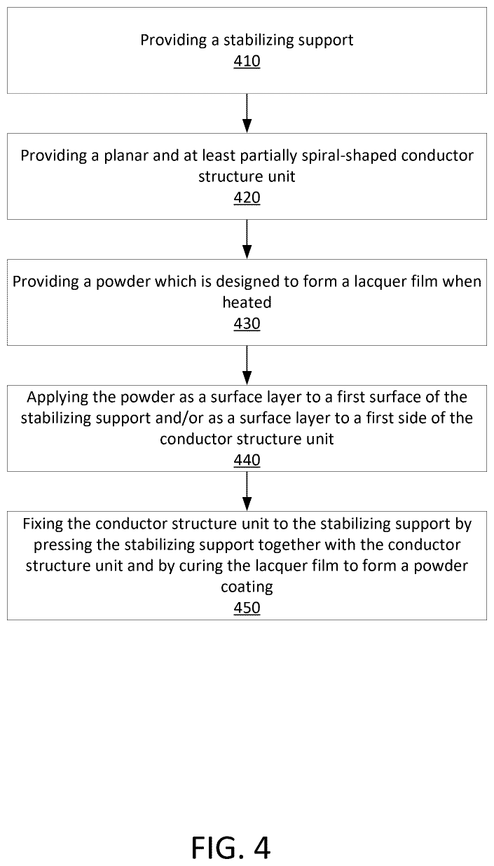

FIG. 4 illustrates a first example flow diagram, in accordance with an embodiment of the present disclosure. FIG. 4 shows a flow diagram of a first embodiment of a method according to the disclosure for producing a saddle coil for a gradient coil unit. Process step 410 involves providing a stabilizing support 11. Process step 420 involves providing a planar and at least partially spiral-shaped conductor structure unit 12. Process step 430 involves providing a powder which is designed to form a lacquer film when heated. Process steps 410, 420, and 430 can also be performed at least in part simultaneously.

In process step 440, the powder is applied as a surface layer to a first surface 11a of the stabilizing support 11 and/or as a surface layer to a first side 12a of the conductor structure unit 12, wherein the powder is exposed to a temperature of e.g. between 140° C. and 220° C. and forms a lacquer film which at least partially wets the first surface and/or the first side. Process step 450 involves fixing the conductor structure unit 12 to the stabilizing support 11 by pressing the stabilizing support 11 together with the conductor structure unit 12 and by curing the lacquer film to form a powder coating 23, with the first side 12a of the conductor structure unit 12 facing the first surface 11a of the stabilizing support 11.

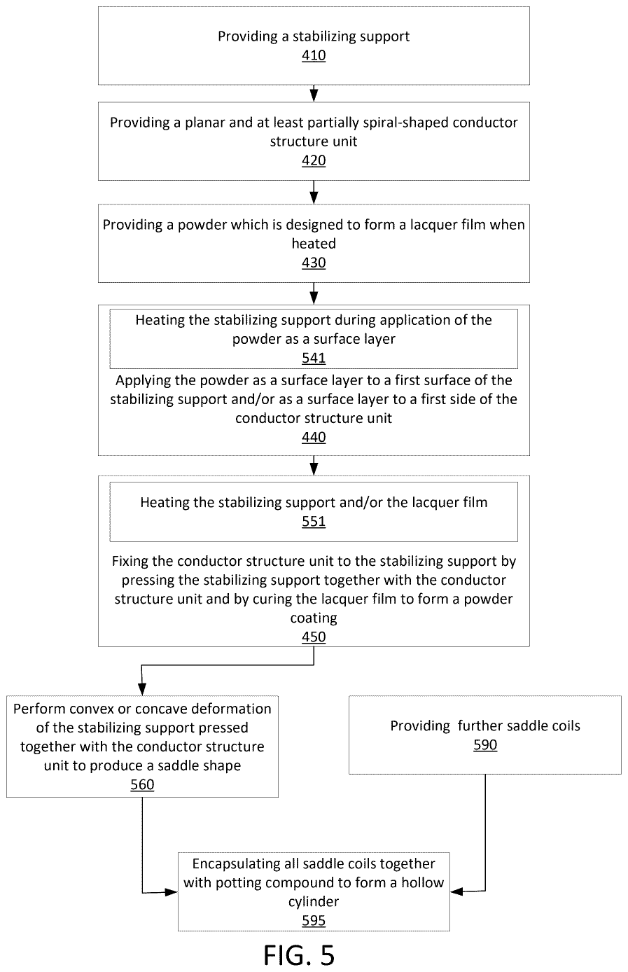

FIG. 5 illustrates a second flow diagram, in accordance with an embodiment of the present disclosure. FIG. 5 shows a flow diagram of a second embodiment of a method according to the disclosure. This differs from the first embodiment with respect to process steps 541, 551, 560, 590, and 595 in that process steps 541, 551, 560, and 590 can be combined, independently of one another, with the first embodiment.

Process step 541 involves heating the stabilizing support 11 during application of the powder as a surface layer in process step 440. Process step 551 involves heating the stabilizing support 11 and/or the lacquer film to a temperature of between 140° C. and 220° C. as part of process step 150. Process steps 541 and 551 may be particularly well integrated with one another by carrying out process steps 440 and 450 without intermediate cooling. The additional process step 560 may comprise convex or concave deformation of the stabilizing support 11 pressed together with the conductor structure unit 12 to produce a saddle shape, thereby forming a saddle coil. Process step 590 involves providing further saddle coils which, in process step 595, are encapsulated together with the produced saddle coil with potting compound to form a hollow cylinder. Process steps 590 and 595 may therefore be used to produce a gradient coil unit.

Although the disclosure has been illustrated and described in detail on the basis of the preferred embodiments, the disclosure is not limited by the disclosed examples, and further variations may be derived therefrom by persons skilled in the art without departing from the scope of protection of the disclosure. Independent of the grammatical term usage, individuals with male, female or other gender identities are included within the term.

What is claimed is:

1. A method for forming a saddle coil for a gradient coil unit, comprising:
providing a stabilizing support;
providing a planar and at least partially spiral-shaped conductor structure;
applying a powder as a surface layer to a first surface of the stabilizing support and/or as a surface layer to a first side of the conductor structure,
wherein the first side of the conductor structure faces the first surface of the stabilizing support;
exposing the powder to a temperature of between 140° C. and 220° C. to cause the powder to form a lacquer film that at least partially wets the first surface of the stabilizing support and/or the first side of the conductor structure; and
fixing the conductor structure to the stabilizing support by:
pressing the stabilizing support together with the conductor structure; and
curing the lacquer film to form a powder coating.

2. The method as claimed in claim 1, wherein the powder comprises an epoxy.

3. The method as claimed in claim 1, wherein the powder comprises polyurethane.

4. The method as claimed in claim 1, wherein the powder is free from solvents and/or free from per- and polyfluorinated alkyl compounds.

5. The method as claimed in claim 1, wherein the powder coating has a thickness between 10 μm and 200 μm.

6. The method as claimed in claim 1, wherein the powder coating and/or the lacquer film are formed pore-free.

7. The method as claimed in claim 1, wherein the curing of the lacquer film to form the powder coating comprises a chemical curing.

8. The method as claimed in claim 1, further comprising:
heating the stabilizing support during the applying of the powder.

9. The method as claimed in claim 1, further comprising:
heating the stabilizing support and/or the lacquer film to a temperature between 140° C. and 220° C. during the fixing of the conductor structure to the stabilizing support.

10. The method as claimed in claim 1, wherein the conductor structure comprises a copper wire having a coated surface.

11. The method as claimed in claim 1, further comprising:
forming the saddle coil by convex or concave deformation of the stabilizing support pressed together with the conductor structure to produce a saddle shape.

12. The method as claimed in claim 1, further comprising:
providing further saddle coils; and
encapsulating the saddle coil and the further saddle coils with a potting compound to form a hollow cylinder.

13. A saddle coil for a gradient coil assembly, comprising:
a stabilizing support;
a planar and at least partially spiral-shaped conductor structure; and
a powder coating that bonds the conductor structure to the stabilizing support over a surface area,
wherein the stabilizing support and the conductor structure are bonded together and comprise a convex or concave shape.
